(19) United States
(12) Patent Application Publication
(10) Pub. No.: US 2003/0011324 A1
(43) Pub. Date: Jan. 16, 2003

(54) Plasma display

(76) Inventor: Jung Dong Lee, Atlanta, GA (US)

Correspondence Address: Lance D. Reich, Esq., BOCKHOP & REICH, LLP, Bldg. 400, Suite 300, 3235 Satellite Blvd., Duluth, GA, 30096, US

(21) Appl. No.: 09/902,993

(22) Filed: Jul. 11, 2001

(51) Int. Cl. G05F 1/00

(52) U.S. Cl. 315/291; 315/169.1

(57) ABSTRACT

An ornamental plasma display having a conical bulb with an upper end and a lower end, the bulb tapering from the lower end to the upper end, and the bulb further having an outer bulb portion and an inner bulb portion hermetically connected with said outer bulb portion thereby creating a hermetically sealed chamber. The hermetically sealed chamber has a discharging gas which causes illuminating arcs of plasma upon an electrical discharge occurring therethrough. The plasma display further has a conductor disposed within the inner bulb portion, and a control circuit for selectively providing electricity of varying voltage and frequency to the conductor. The control circuit alters the electricity to the conductor upon a ground being placed to the outer wall of the outer bulb portion.

### BACKGROUND OF THE INVENTION

1. Field of the Invention

The present invention generally relates to ornamental plasma displays and their construction. More particularly, the present invention relates to an ornamental plasma display having an improved control circuit and a plasma bulb design.

2. Description of the Related Art

Several display lamps are known in the art which display arcs of plasma from an electrical discharge, sometimes imitating lightning. These display lamps typically have a nonconductive shell containing specific ionizable gases, such as neon (Ne), argon (Ar), krypton (Kr), helium (He), and xenon (Xe), and one or more electrodes disposed in the inert atmosphere. High voltage electricity is the directed to the electrodes to specifically cause arcs of plasma in the inert atmosphere. Several designs utilize either spherically shaped sealed envelopes or cylindrical sealed envelopes to hold the inert gases captive. In some instances, the intensity and location of a specific plasma arc discharge in the plasma display lamp can be altered with the proximity of a conductive body such as a person's hand.

U.S. Pat. No. 4,956,579 and U.S. Pat. No. Des. 326,574 disclose a plasma display having a double-walled enclosure. The plasma display includes a gas-containing envelope that forms a cylinder and an electrode is disposed on the sealed envelope to cause plasma arcs therein upon the supply of a constant alternating current (AC) signal from an AC adapter to the electrode. The '579 patent does not disclose a specific composition of ionizable gas for use in the envelope or the use of voltage and frequency manipulation to cause changes in the plasma arcs, and their interrelation.

U.S. Pat. No. 4,754,199 discloses a self-contained gas discharge display device that includes a single electrode in a discharge chamber comprised of the upper portion of a dome. The device of this patent particularly includes a shield means to establish discharge-supporting electric fields in the discharge chamber, the shield being located between the base and the discharge chamber.

U.S. Pat. No. 4,379,253 discloses an ornamental discharge lamp and is particularly directed towards the power supply of the lamp. The lamp includes one or more electrodes in a light-transmitting envelope containing an ionizable fluid. The ornamental lamp uses an oscillator and by modifying the oscillator voltage to the electrode(s) in the lamp, changing the position of the electrodes, and changing the discharging gas, effects changes in the discharge designs and colors. The voltage disclosed for transmission to the electrode(s) is 10,000 volts or higher.

U.S. Pat. No. 5,281,898 discloses a display device which has a double-walled envelope with a plurality of electrodes therein. The plurality of electrodes receives an AC high voltage current (up to 15,000 volts) to cause a discharge between the electrodes in the envelope. The cycling of the alternating current (120 hz) causes re-ionization of the discharging gas and establishes a new plasma arc from one electrode to the other to cause a “flickering display.”

One significant problem with earlier plasma displays is that when and external ground is placed against the outer surface of the plasma bulb, the increased plasma arcing to that point on the bulb increases the heat on the external surface. If a person were to purposely hold their fingers or hand to prior art bulbs, a burn could result.

Accordingly, it would be advantageous to provide a plasma display lamp that provides illuminating arcs of plasma, but does not allow the surface of the lamp to overheat when grounded. It would further be advantageous to provide a plasma bulb that can alter the direction of discharging plasma arcs therewithin. It is to the provision of such an improved plasma display that the present invention is primarily directed.

### SUMMARY OF THE INVENTION

Briefly described, the present invention is a plasma display including a conical bulb having an upper end and a lower end, with the bulb tapering from the lower end to the upper end, and the bulb further having an outer bulb portion and an inner bulb portion hermetically connected with said outer bulb portion thereby creating a hermetically sealed chamber. The inner bulb portion has an inner surface and an outer surface facing the chamber with the hermetically sealed chamber including a discharging gas. A conductor is disposed within the inner bulb portion, and a control circuit selectively provides electricity of varying voltage and frequency to the conductor which causes visible arcs of plasma between the inner bulb portion to the outer bulb portion, and varying the voltage of the electricity changes the visual appearance of the plasma arcs.

Further, the control circuit selectively alters the electricity to the conductor upon a ground being placed on the outer wall of the outer bulb portion, which lessen the risk of excessive heat building up on the exterior surface of the plasma bulb. The control circuit preferably lessens the wattage of the electricity to the conductor upon a ground being placed to the outer wall of the outer bulb portion.

In one embodiment, the outer wall of the outer bulb portion is less than one inch from the inner bulb portion at the upper end of the bulb, and the outer wall of outer bulb portion is greater than one inch from the inner bulb portion at the bottom end of the bulb. A ground plate is then preferably placed proximate to the lower end of the bulb such that at least some of the arcs of plasma within the bulb are attracted to the ground plate.

The present invention also includes a control circuit for a plasma bulb of a plasma display, where the circuit includes a line filter, a recitifier, a voltage drop element for dropping the voltage input from the rectifier, a power switch for selectively closing the control circuit, an output driver, a flyback transformer providing electricity to the electrode of the plasma display, and a switching driver for selectively altering the power output to the plasma bulb based upon feedback from the flyback transformer. The circuit further preferably includes a microphone and audio amplifier for altering the voltage in relation to audio input into the microphone.

The voltage drop element is preferably a zener diode. Further, the circuit switching driver preferably lowers the wattage of the electricity supplied to the electrode of the plasma bulb upon a ground being placed on the outer wall of the outer bulb portion. The switch driver preferably includes one or more carbon resistors to lower the wattage of the electricity.

Accordingly, it is an object of the present invention to provide an ornamental plasma display which can minimize the risk of excess heat build-up on the surface of the plasma bulb when an external ground is applied to the surface. Further, it is an object of the plasma display to provide a plasma bulb that can have the direction of the discharging plasma arcs selectively altered.

Other objects, features, and advantages of the present invention will become apparent after review of the hereinafter set forth Brief Description of the Drawings, Detailed Description of the Invention, and the Claims.

### BRIEF DESCRIPTION OF THE DRAWINGS

FIG. 1 is a side perspective view of the plasma display having an obelisk cover over the plasma-display bulb.

FIG. 2 is a cross-section of the plasma display bulb.

FIG. 3 is a block diagram of the control circuit for the operation of the plasma display.

FIG. 4 is a schematic diagram of the preferred control circuit for the plasma display.

### DETAILED DESCRIPTION OF THE INVENTION

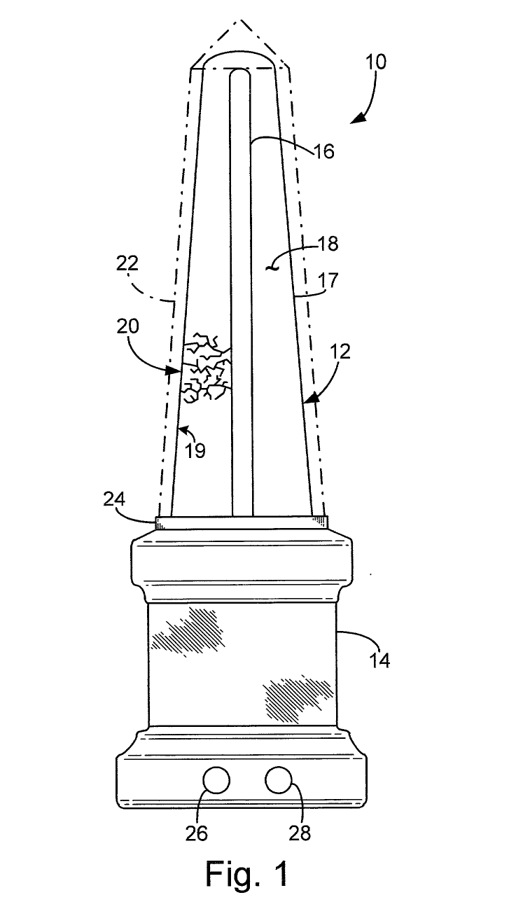

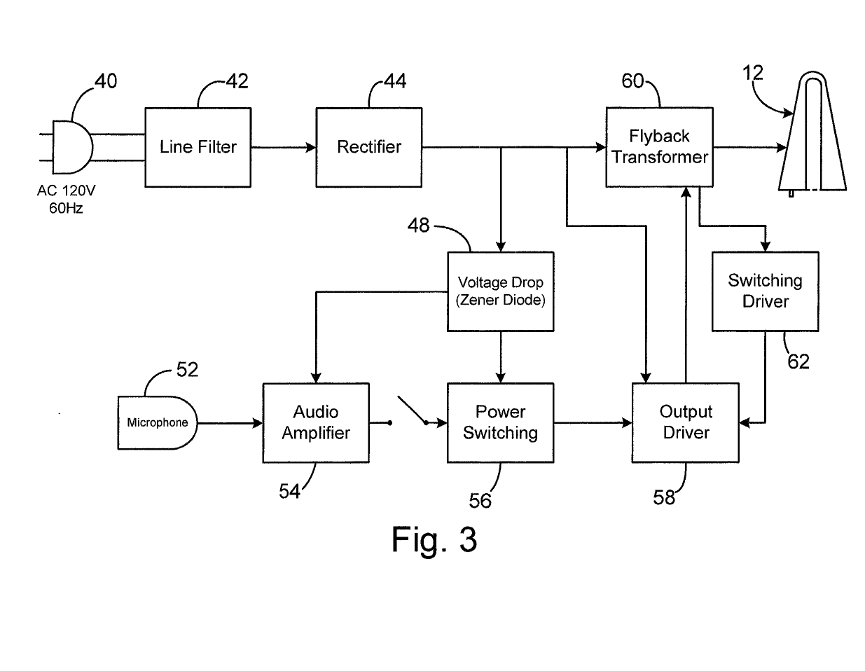

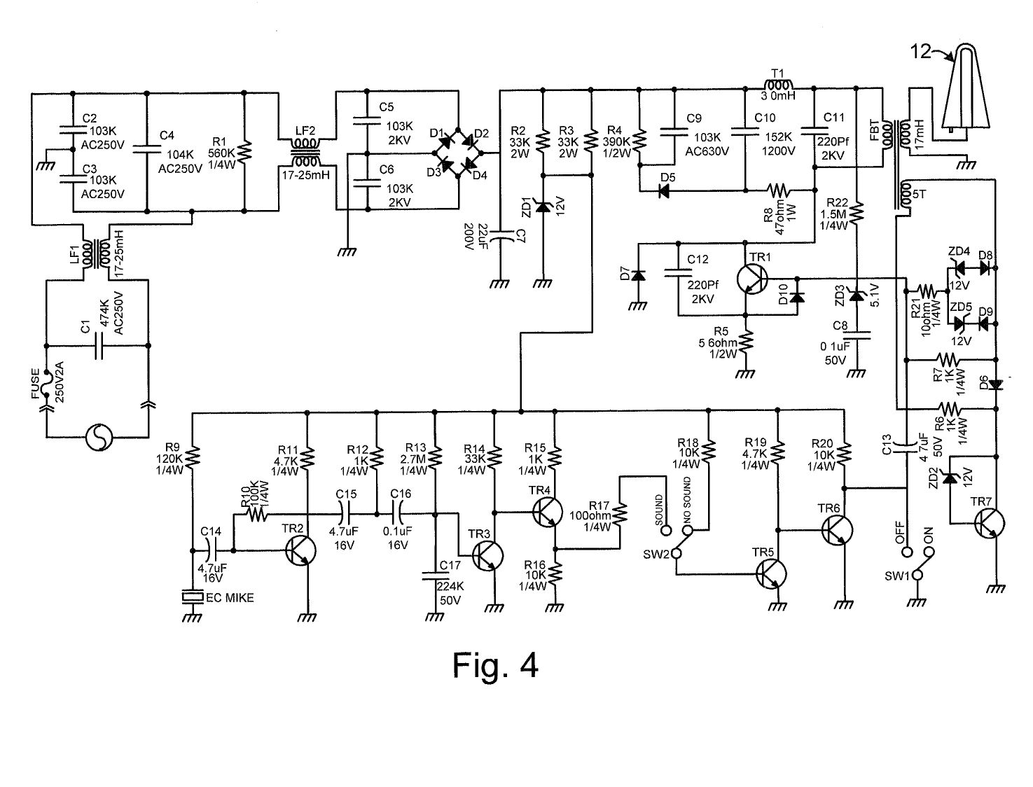

With reference to the figures in which like numerals represent like elements throughout, FIG. 1 illustrates the plasma display 10 in an obelisk lamp configuration. The plasma display 10 includes a plasma bulb 12 having an inner bulb portion 16 and an outer bulb portion 17 hermetically connected with said outer bulb portion 17, thereby creating a hermetically sealed chamber 18. The plasma bulb 12 rests on a base 14 containing the control circuit (FIGS. 3 and 4) for the plasma display 10. When electricity is selectively sent to the plasma bulb 12 as further discussed herein, discharging plasma arcs 20 occur from the inner bulb portion 16 to the inner surface 19 of the outer bulb portion 17, within the hermetically sealed chamber 18. The base 14 also includes the plasma display controls, such as an on/off switch 26, and an audio switch 28, which causes the plasma arcs 20 to be altered in accord with changes in audio input from a microphone 52 on the control circuit (FIGS. 3 and 4).

The plasma bulb 12 is enchased within an obelisk-shaped clear cover 20 to protect the plasma bulb 12. The cover 22 fits within a lip 24 to hold the cover firmly on the base 14.

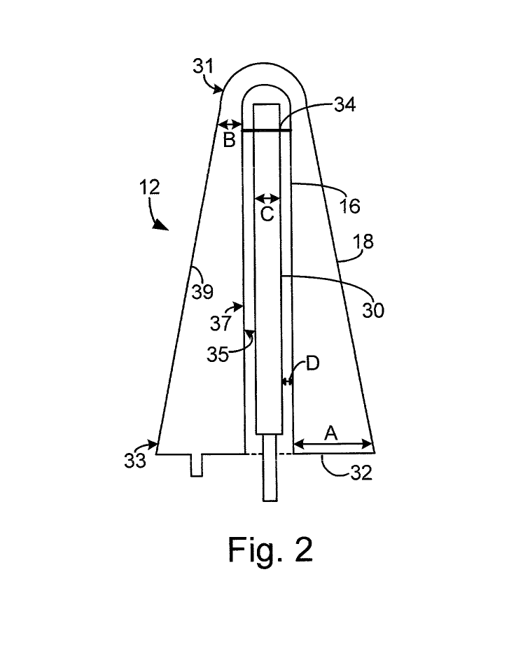

With reference to FIG. 2, the plasma bulb 12 is shown in cross-section with the inner bulb portion 16 has an inner surface 35 and an outer surface 37 facing the chamber 18. A conductor 30 is within the inner bulb portion 16 and electricity is selectively provided to the conductor 30. The plasma display bulb 12 is a conical bulb having an upper end 31 and a lower end 33, the bulb 12 tapering from the lower end 33 to the upper end 31. The distance between the inner bulb outer surface 37 and outer bulb inner surface 19 is over 1 inch (Distance A) at the lower end 33 and less than 1 inch at the upper end 31 (Distance B).

The conductor 30 is preferably cylindrically shaped and is vertically installed in the center of the inner bulb portion 16. The conductor 30 diameter is preferably in a range of 3/16^{th} of an inch to ½ an inch (Diameter C), and the conductor 30 is constructed from a conductive metal such as Aluminum, Copper, Steel, and can be solid or coiled wire. The distance between the conductor 30 and inner bulb portion inner surface 35 is preferably in a range of 1 cm to 1.5 cm (Distance D). If the plasma arcs 20 are desired to be directed downward during operation of the plasma display 10, a ground plate 32 is placed on the lower end 33 of the bulb 12 to make the plasma arcs 20 flow downward within some or all of the bulb 12.

A discharging gas is filled into the hermetically sealed chamber 18. Thus, supplying voltage to the conductor 30 causes visible arcs of plasma 20 within the discharging gas between the inner bulb portion 16 and outer bulb portion 17. Selectively varying voltage and frequency of the electricity provided to the conductor 30 causes changes in the locations, shape and color of the discharge. Furthermore, the inclusion of the ground plate 32 causes the plasma arcs 20 to flow to the lower end 33 of the bulb 12. Accordingly, when a sensor or other device is connected to the electrical supply, as further discussed below, the frequency and voltage are selectively variegated in accord with sensor-positive input, such as sound, light, heat, infrared, and other sensed characteristics as are known in the art, and the plasma arcs 20 are selectively altered in accord therewith.

The discharging gas in the chamber 18 can be any inert gas or combination of inert gases known in the art to produces colorful arcs of plasma discharge when a high voltage is passed therethrough. One discharging gas which can be sealed within the chamber 18 is preferably comprised of 93%-96% Kr; 2%-5% Xe; 1%-4% He; 1%-4% N; and 50-500 ppm O. Such gas will effect red-blue arcs of plasma between the outer bulb portion 17 and inner bulb portion 16 and the discharges are optimized when the preferred ranges of frequency and voltage provided to the plasma display, as further discussed herein, are used. A further discharging gas that can be placed within the sealed chamber 18 is comprised of: 93%-96% Ne; 2%-5% Xe; 1%-4% He; 1%-3% N; and 50-500 ppm O. Such discharging gas provides mostly white plasma arcs with slight shades of green when an electric current is applied.

When a high-voltage electricity is applied to the conductor 30, the whole length of the conductor 30 causes plasma arcs 20 to occur from the inner bulb portion 16 to the outer bulb portion 17 at substantially all portions of the chamber 18. If the ground plate 32 is installed at the lower end 33 of the bulb 12, the plasma arcs 20 will flow from the inner bulb portion 16 to the ground plate 32, at least at the lower end of the conductor 30. As the plasma arcs 20 move around the conductor 30 in a horizontal direction only, the plasma arcs 30 appear fixed to a user observing the plasma display 10. When the ground plate 32, or other conductor is placed on the lower end 33 of the bulb 12 to move the plasma arcs 20 in a vertical direction causes a visual effect of the continuous motion of the plasma arcs 30 toward the lower end 33 of the within at least the lower third of the plasma bulb 12. The plasma arcs 20 can be selectively changed from the fixed horizontal state to the moving state by selective activation of the ground plate 32, to create a visual flickering effect wherein the plasma arcs 20 appear scattered within the chamber 18. The speed of the movement of the plasma arcs will vary according to the discharge gas used in the chamber 18, the level of the high voltage electricity applied to the conductor 30, and the size of the bulb 12.

FIG. 3 is a block diagram illustrating the control circuit for the plasma bulb 20, and FIG. 4 is a schematic diagram for the preferred circuit implementing the control as embodied in FIG. 3. The circuit receives a 120 V, 60 Hz AC, power source line 40, which directs the power to a line filter 42. The line filter 42 removes the conductive noise from the power source line 40. The line filter 42 is preferably comprised of an inductor and condenser.

The power is then passed to a rectifier 44 to rectify the voltage to supply an even 160 V DC. The rectifier is preferably a bridge diode. The voltage is then dropped at a voltage drop 48, preferably a zener diode, or other resistor, and the stabilized power supply of 12 V DC is provided to the power switching 56 for the plasma display. The power switching 56 controls the operation of the plasma bulb 20 and can be mechanically actuated by on/off switch 26. If the plasma display 10 is alter the plasma arcs in relation to audio input from a microphone 52, then an audio amplifier 54, which is in communication with the microphone 52, amplifies the voltage into the power switching 56 to effect a voltage change in the system. The audio feedback control switch 28 on the plasma bulb 20 will select or deselect the audio amplifier 54 to alter the voltage.

The power switching 60 passes the voltage to the output driver 58 which then passes the voltage to the flyback transformer 46 and the switching driver 62. The flyback transformer 60 supplies about 6 kV at about 90 Khz to the plasma bulb 20. The switching driver 62 allows feedback of the voltage to the output driver 58 to ensure safe operation of the plasma bulb 20 within an acceptable range of voltage. The switching driver 62 also diminishes the plasma arc intensity when an external ground is applied to the bulb 20 of the plasma display 10.

During regular operation, the voltage from the flyback transformer 60 to the plasma bulb 20 is higher than the voltage from the voltage drop 48. However, when an external ground is applied to the plasma bulb 20 surface, the inductance of the voltage changes the load on the flyback transformer 60 which can drop the voltage below that of the voltage drop 48, and thus, a comparison between the voltage sent from the rectifier 44 and that from the output driver 58 will indicate the inductance at the plasma bulb 20. Upon the voltage change from inductance, the switching driver 62 lowers the power sent to the flyback transformer 60 from the output driver 58 such that the power output is lessened. It is preferred that the power output be lowered by at least 50% to reduce the chance of persons burning their hands and fingers from prolonged contact with the surface of the plasma bulb 20. The bulb operating voltage is about 8 KV to 11 KV and within a frequency of 80 KHz to 110 KHz.

The safety function of circuit lowering the power output to the bulb 12 occurs when the bulb 12 breaks or demonstrates an abnormal phenomenon. The operation of the element is stopped and output power is controlled by using zener diode 48 when it is lower than the zener electric potential. If the bulb 12 is destroyed, the circuit is opened. When problems are sensed on the voltage output to the conductor 30, the frequency of the voltage is stabilized and the potential of the zener diode is lowered accordingly such that the output power to the conductor 30 is lowered. When the output voltage to the conductor 30 is returned to normal, the power is returned to normal to match the zener potential. In one embodiment of the present circuit, the zener diode operates at 6V, and when problems occur, the zener diode drops the potential to less than 3V. If the zener potential drops further, the flow to the plasma bulb 12 is stopped.

While there has been shown a preferred embodiment of the present invention, it is to be understood that certain changes may be made in the forms and arrangement of the elements and steps of the method without departing from the underlying spirit and scope of the invention as is set forth in the claims.

What is claimed is:

1. A plasma display, comprising:
a conical bulb having an upper end and a lower end, the bulb tapering from the lower end to the upper end, the bulb further having an outer bulb portion and an inner bulb portion hermetically connected with the outer bulb portion thereby creating a hermetically sealed chamber, the inner bulb portion having an inner surface and an outer surface facing the chamber, the hermetically sealed chamber including a discharging gas;
a conductor disposed within the inner bulb portion; and
a control circuit for selectively providing electricity of varying voltage and frequency to the conductor of the inner bulb portion,
wherein supplying voltage to the conductor causes visible arcs of plasma between the inner bulb portion to the outer bulb portion and varying the voltage of the electricity changes the visual appearance of the plasma arcs, and
wherein the control circuit alters the electricity to the conductor upon a ground being placed to the outer wall of the outer bulb portion.

2. The plasma display of claim 1, wherein the outer wall of the outer bulb portion is less than one inch from the inner bulb portion at the upper end of the bulb, and the outer wall of outer bulb portion is greater than one inch from the inner bulb portion at the bottom end of the bulb.

3. The plasma display of claim 1, wherein the discharging gas selected from the group comprised of:
the combination of: 93-96% Kr, 2%-5% Xe, 1%-4% He, 1%-3% N, and
50-500 ppm O; and the combination of: 93%-96% Ne, 2%-5% Xe, 1%-4% He, 1%-3% N, and 50-500 ppm O

4. The plasma display of claim 1, wherein the display includes a ground plate proximate to the lower end of the bulb such that at least some of the arcs of plasma within the bulb are attracted to the ground plate.

5. The plasma display of claim 1, wherein said control circuit provides a voltage in a range of 8 KV to 11 KV, and in a frequency range of 80 KHz to 110 KHz.

6. The plasma display of claim 1, wherein the control circuit lessens the wattage of the electricity to the conductor upon a ground being placed to the outer wall of the outer bulb portion.

7. A conical bulb for displaying illuminating arcs of plasma, comprising an upper end and a lower end, the bulb tapering from the lower end to the upper end, the bulb further having an outer bulb portion and an inner bulb portion hermetically connected with the outer bulb portion thereby creating a hermetically sealed chamber, the inner bulb portion having an inner surface and an outer surface facing the chamber.

8. The bulb of claim 7, further including a ground plate at the lower end of the bulb.

9. The bulb of claim 7, wherein the outer wall of the outer bulb portion is less than one inch from the inner bulb portion at the upper end of the bulb, and the outer wall of outer bulb portion is greater than one inch from the inner bulb portion at the bottom end of the bulb.

10. The bulb of claim 7, wherein the bulb is comprised of glass.

11. A control circuit for a plasma bulb of a plasma display, the plasma display including an electrode, the circuit comprising:
a line filter;
a recitifier;
a voltage drop element for dropping the voltage input from the rectifier;
a power switch for selectively closing the control circuit;
an output driver;
a flyback transformer providing electricity to the electrode of the plasma display; and
a switching driver for selectively altering the power output to the plasma bulb based upon feedback from the flyback transformer.

12. The circuit of claim 11, wherein the voltage drop element is a zener diode.

13. The circuit of claim 11, further including a microphone and audio amplifier for altering the voltage in relation to audio input into the microphone.

14. The circuit of claim 11, wherein the switching driver lowers the wattage of the electricity supplied to the electrode of the plasma bulb upon a ground being placed on the outer wall of the outer bulb portion.

15. The circuit of claim 11, wherein the switch driver includes one or more carbon resistors to lower the wattage of the electricity supplied to the electrode of the plasma bulb upon a ground being placed on the outer wall of the outer bulb portion.
